(19) United States
(12) Patent Application Publication
(10) Pub. No.: US 2010/0176078 A1
(43) Pub. Date: Jul. 15, 2010

(54) Auxiliary Device for Installing the Lower and Upper Jib Support of an Adjustable Auxiliary Boom on a Mobile Crane

(75) Inventors: Klaus Conrad, Hornbach (DE); Jürgen Appel, Contwig (DE); Peter Orfey, Homburg (DE); Udo Biwer, Eppelborn (DE)

Correspondence Address: COHEN, PONTANI, LIEBERMAN & PAVANE LLP, 551 FIFTH AVENUE, SUITE 1210, NEW YORK, NY, 10176, US

(73) Assignee: Terex=Demag GmbH, Zweibruecken (DE)

(21) Appl. No.: 12/440,823

(22) PCT Filed: Jul. 18, 2008
(86) PCT No.: PCT/DE08/01214

§ 371 Date: Nov. 4, 2009

(51) Int. Cl. B66C 23/42

(52) U.S. Cl. 212/300

(57) ABSTRACT

A device for installing the lower and upper jib support of an adjustable auxiliary boom.

The device includes
a setup frame which is connected to the lower jib support
a tie rod section one end of which can be connected to the hoist cable of the main hoisting gear whereas the other end is hinged to the top of the lower jib support

and
a tensile member section between the lower jib support and the upper jib support.

The invention pertains to an auxiliary device for installing the lower and upper jib support of an adjustable auxiliary boom, which is mounted at the top of the main boom of a mobile crane.

At the present time, auxiliary booms must be installed by the use of an assist crane. Upon consideration of the setup procedure, it can be seen that the following various individual steps are necessary:

First, the lower jib support is raised by an assist crane and set down on a rod. The crane operator must then walk along this raised jib support to disengage the sling of the assist crane. This activity is not unhazardous, because the jib support, in the raised position, can be up to 6 m above the ground. After the sling of the assist crane has been disengaged, the actual setup process, which is carried out by the crane to be erected, can be continued.

The take-down process must be carried out in the opposite manner; that is, the lower jib support is set down on a rod by the crane to be taken down; the crane operator, after walking along the jib support, hooks on the sling of the assist crane and raises the lower jib support briefly to release the rod. In parallel with the lowering of the lower jib support, the rod is then guided by hand with a cable so that it, together with the lower jib support, can be laid down in the transport position.

This job therefore requires, first, an assist crane, and second, it requires that the crane operator perform work which is not unhazardous on the jib support.

The object of the invention is therefore to create a possibility by means of which adjustable auxiliary booms can be set up and taken down more quickly and safely.

This object is achieved according to the invention by the features of claim 1 and of claim 10.

Preferred embodiments can be derived from the subclaims.

The inventive device is to be explained below on the basis of the drawings.

The figures show the crane vehicle only in schematic fashion, and only those parts are described below which are important for an understanding of the invention.

These parts are designated as follows:

1 undercarriage

2 revolving superstructure

3 main boom

4 adapter for adjustable auxiliary boom (head connector)

5 adjustable auxiliary boom

6 setup frame

7 hoist cable 1 of the main hoisting gear

8 lower jib support

9 upper jib support

10 main hoisting gear

11 tensile member section

12 tie rod section

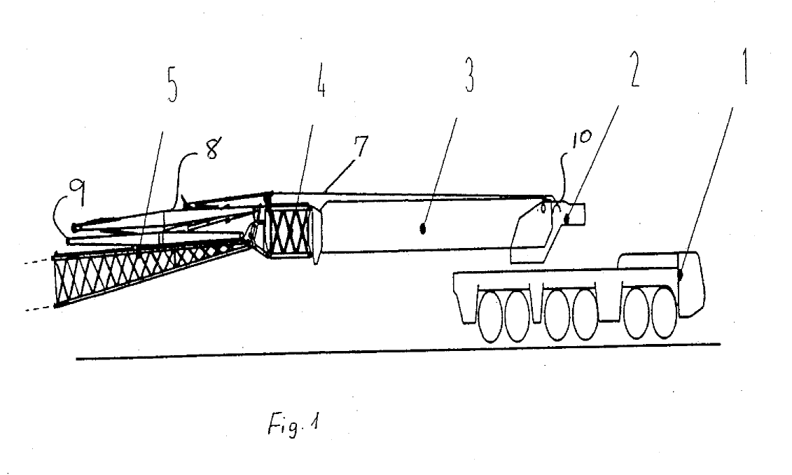

FIG. 1

The adjustable auxiliary boom 5 is attached to the head of the main boom 3 by way of an adapter 4 (the adapter is not absolutely necessary for the achievement of the present objective). The attachment is accomplished by means of suitable auxiliary equipment such as an assist crane or a forklift truck. For transport reasons, the two jib supports 8 and 9 are resting flat on the auxiliary boom 5. The hoist cable 7 is unwound from the main hoisting gear 10 of the mobile crane and connected to the multi-element tie rod section 12. This section is connected permanently to the lower jib support 8. The two jib supports are connected to each other by a tensile member section 11.

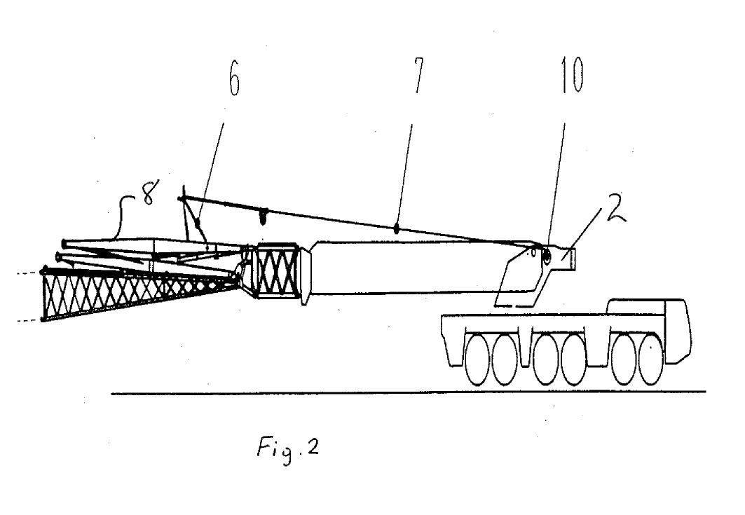

FIG. 2

As the hoist cable 7 is being wound up onto the hoisting gear 10, the setup frame 6 begins to straighten up; the tie rod section 12 begins to get taut, first on the right of the setup frame 5, then also on the left of the setup frame 6, until the lower jib support 8 has also been raised.

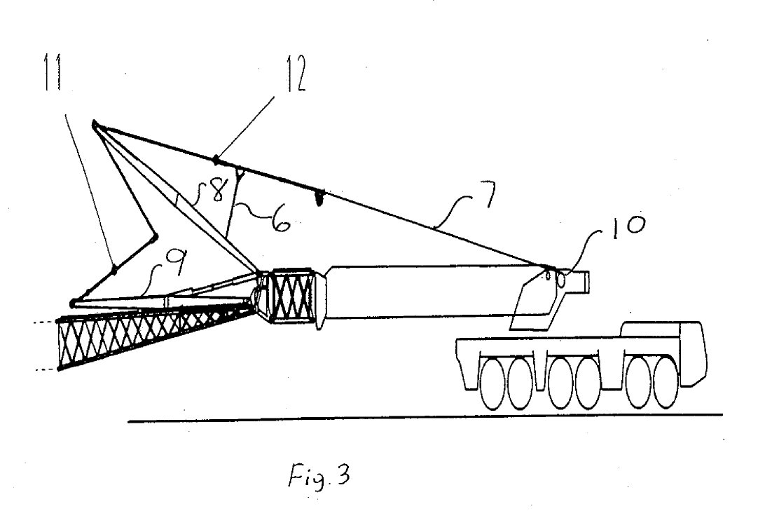

FIG. 3

The main hoisting gear 10 continues to wind up the cable; the tensile member section 11 between the jib supports 8 and 9 begins to tauten. The setup frame 6 is prevented from falling backward out of position by the stop screws.

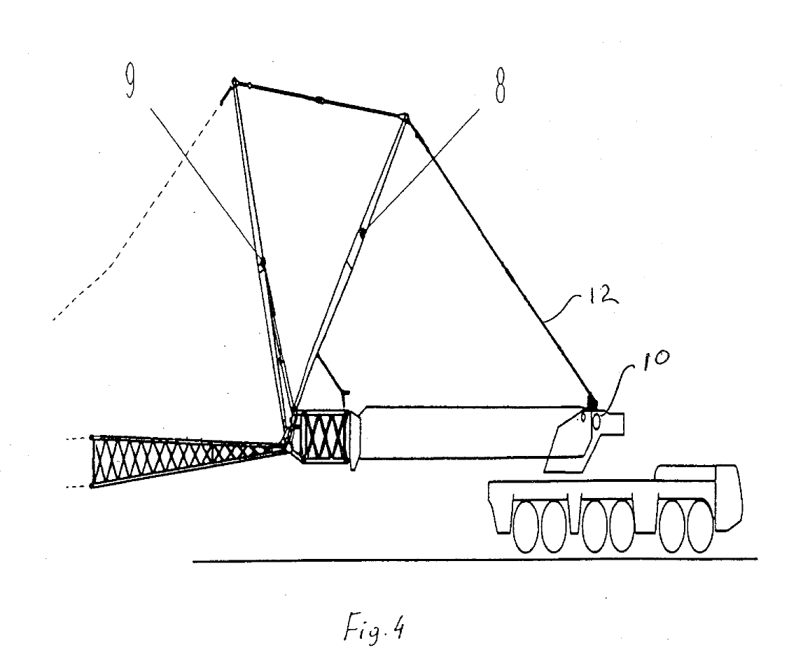

FIG. 4

The tie rod section 12 has arrived in its end position in front of the main hoisting gear 10; the jib supports 8 and 9 are also in their end positions. The procedure is complete.

Take-down proceeds in the opposite manner.

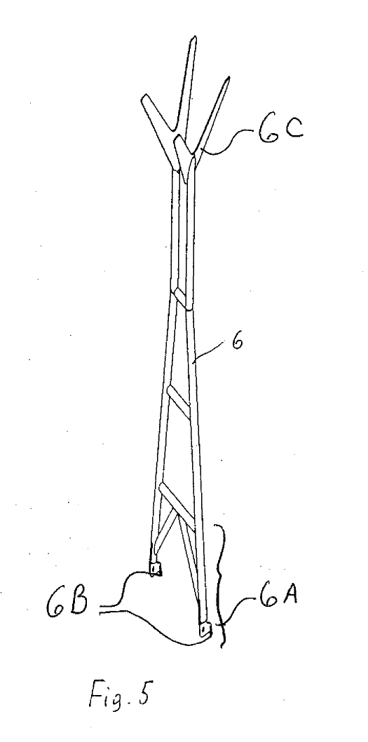

FIG. 5

This figure shows an exemplary embodiment of the setup frame 6, which consists here of a welded structure, which is supported with freedom to rotate (to pivot) on the lower jib support. Stops, which prevent the setup frame from falling over, are provided on the bearing feet. At the upper end of the setup frame there is a fork, in which the previously described tie rod section 12—as can also be seen in FIGS. 1-4—can be laid.

During take-down, the stop screws also serve simultaneously to hold the setup frame 6 in position in such a way that the tie rod section 12 is picked up again by the forked shape of the setup frame 6.

During the setup of the auxiliary luffing boom, this tie rod section 12 pulls the setup frame 6 up along with it, until the frame comes to rest against the stops. In corresponding fashion, as the tie rod section 12 is released during take-down, the setup frame 6 is carried along and thus brought into its transport position (FIG. 1).

1.-10. (canceled)

11. An auxiliary device for installing an upper jib support and a lower jib support of an adjustable auxiliary boom that is mounted on a head of a main boom of a mobile crane, the auxiliary device comprising:
a setup frame coupled to the lower jib support;
a tie rod section, the tie rod section having a first end coupled a hoist cable of a main hoisting gear of the main boom and a second end coupled to the lower jib support the setup frame interacting with the tie rod section during winding of the hoist cable on the main hoisting gear to facilitate lifting of the lower jib support from the auxiliary boom during setup of the auxiliary boom; and
a tensile member section coupled between the lower jib support and the upper jib support.

12. The auxiliary device according to claim 11, wherein the tie rod section comprises a plurality of members, each of the plural members coupled to each other.

13. The auxiliary device according to claim 11, further comprising an adapter configured to couple the auxiliary boom the head of the main boom.

14. The auxiliary device according to claim 11, wherein the lower jib boom and the upper jib supports are configured to be laid flat on the auxiliary boom for transport.

15. The auxiliary device according to claim 12, wherein the tie rod section is permanently coupled to the lower jib support.

16. The auxiliary device according to claim 11, wherein the two jib supports are permanently coupled to one another by the tensile member section.

17. The auxiliary device according to claim 11, wherein the setup frame is permanently coupled to the lower jib support.

18. The auxiliary device according to claim 11, wherein the setup frame is pivotably coupled to the lower jib support.

19. The auxiliary device according to claim 11, wherein a first end of the setup frame further comprises a fork-like shape configured to hold the tie rod section.

20. A method for setting up an auxiliary boom, which is mounted on the head of the main boom of a mobile crane, the method comprising:
unwinding a hoist cable from a main hoisting gear of the mobile crane;
coupling the hoist cable to an end of a tie rod section that is opposite an end of the tie rod section coupled to the lower jib support;
winding the hoist cable on the main hoisting gear of the mobile crane;
straightening of a setup frame in response to the winding of the hoist cable;
raising the lower jib support by tightening the tie rod section, first on a hoist side of a setup frame, then on an opposite side of the setup frame;
tightening a tensile member section coupled between an upper and the lower jib supports in response to the continued winding of the hoist cable,
wherein the tie rod section arrives in its end position in front of the main hoisting gear and the upper and lower jib supports are in their respective raised end positions.

21. The auxiliary device according to claim 12, wherein the second end of the tie rod section is pivotably coupled to a tip of the lower jib support;

22. The auxiliary device according to claim 12, wherein the multi-link tie rod section is removeably coupled connected to the lower jib support.

23. The auxiliary device according to claim 11, wherein the setup frame is removeably coupled to the lower jib support.

24. The auxiliary device according to claim 18, wherein a first end of the setup frame further comprises a fork-like shape configured to hold the tie rod section.

25. The auxiliary device according to claim 24, wherein the setup frame is pivoted from a rest position to a working position during winding of the hoist cable.
